(19) United States
(12) Patent Application Publication
(10) Pub. No.: US 2016/0313365 A1
(43) Pub. Date: Oct. 27, 2016

(54) MICROMECHANICAL STRUCTURE FOR AN ACCELERATION SENSOR

(71) Applicant: Robert Bosch GmbH, Stuttgart (DE)

(72) Inventor: Guenther-Nino-Carlo Ullrich, Reutlingen (DE)

(21) Appl. No.: 15/132,975

(22) Filed: Apr. 19, 2016

(30) Foreign Application Priority Data
Apr. 27, 2015 (DE) 102015207637.7

(51) Int. Cl. G01P 15/125

(52) U.S. Cl. CPC G01P 15/125

(57) ABSTRACT

A micromechanical structure for an acceleration sensor, including a seismic mass which is connected to a substrate with the aid of a central connecting element, a defined number of electrodes situated on the substrate, one spring element being situated on each side of the connecting element in relation to a sensing axis.

### CROSS REFERENCE

The present application claims the benefit under 35 U.S.C. §119 of German Patent Application No. DE 102015207637.7 filed on Apr. 27, 2015, which is expressly incorporated herein by reference in its entirety.

### FIELD

The present invention relates to a micromechanical structure for an acceleration sensor. The present invention also relates to a method for manufacturing a micromechanical structure for an acceleration sensor.

### BACKGROUND INFORMATION

Modern sensors for measuring acceleration usually include a silicon micromechanical structure (“sensor core”) and evaluation electronics.

Acceleration sensors for in-plane movements are available. They include a movable (“seismic”) mass and electrodes. When the mass moves, the distances between the electrodes change, so that an acceleration may be detected.

### SUMMARY

An object of the present invention is to provide an improved micromechanical structure for an acceleration sensor.

This object may be achieved according to a first aspect by a micromechanical structure for an acceleration sensor, including:
a seismic mass which is connected to a substrate with the aid of a central connecting element;
a defined number of electrodes situated on the substrate;
a spring element being situated on both sides of the connecting element, in relation to a sensing axis.

In this way, the electrodes are situated closer to the sensing axis so that the arrangement may be less sensitive to a deflection of the substrate orthogonally to the sensing axis. Due to the arrangement of the spring elements directly at the connection to the substrate, space for additional damping structures or springs may be created in the seismic mass.

According to another aspect, the object may be achieved by a method for manufacturing a micromechanical structure for an acceleration sensor, including the steps:
forming a substrate including electrodes provided thereon;
forming a seismic mass;
connecting the seismic mass to the substrate with the aid of a central connecting element; and
forming two spring elements on each side of the connecting element in relation to a sensing axis of the seismic mass.

One advantageous refinement of the micromechanical structure provides that at least one damping element is situated on the seismic mass between the two spring elements. In this way, an available space between the two spring elements may advantageously be used for structural details of the micromechanical structure.

Another advantageous refinement of the micromechanical structure provides that another electrode pair is situated between the two spring elements on the substrate. An available space between the two spring elements may therefore be utilized advantageously in this way.

Another advantageous refinement of the micromechanical structure provides that a first electric potential is applicable to first electrodes, a second electric potential is applicable to second electrodes and a third electric potential is applicable to the connecting element. In this way a detection structure for a micromechanical acceleration sensor is wired electrically in a suitable manner.

The present invention including additional features and advantages is described in detail below on the basis of the figures. The same elements or those having the same function have the same reference numerals. The figures are not necessarily drawn true to scale.

### BRIEF DESCRIPTION OF THE DRAWINGS

FIG. 1 shows a top view of a conventional micromechanical structure for an acceleration sensor.

FIG. 2 shows a top view of a conventional micromechanical structure from FIG. 1 with an indication of electric potentials.

FIG. 3 shows a top view of one specific embodiment of a micromechanical structure according to the present invention for an acceleration sensor.

FIG. 4 shows a basic flow chart of one specific embodiment of the method according to the present invention.

### DETAILED DESCRIPTION OF EXAMPLE EMBODIMENTS

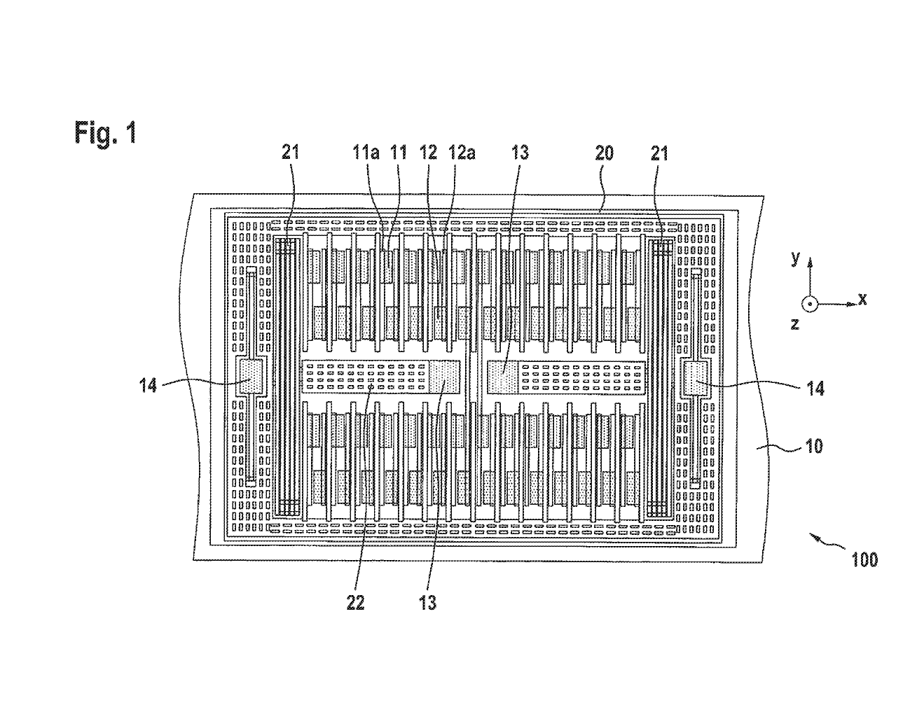

FIG. 1 shows a top view of a conventional micromechanical structure 100 for an acceleration sensor having a so-called “semi-central suspension.” Micromechanical structure 100 includes a seismic mass 20 which is functionally connected to a substrate 10 situated beneath seismic mass 20 with the aid of a centrally situated connecting element 13. First electrodes 11a, which are wired to one another and applied to a first electric potential P1 via connecting elements 11, are situated on substrate 10. In addition, second electrodes 12a are situated on substrate 10 which are wired to one another and applied to a second electric potential P2 via connecting elements 12. Seismic mass 20 is suspended movably with the aid of two spring elements 21, spring elements 21 being each connected to a connecting element 13 via perforated bar and/or web elements 22 designed with an elongated shape. Mechanical stop elements 14 are provided for limiting a deflection of seismic mass 20.

Seismic mass 20 therefore has two connecting elements 13 facing downward toward substrate 10 so that seismic mass 20 is largely independent of substrate warping. In this way, substrate warping may hardly influence or distort a sensor signal. The aforementioned substrate warping has the negative result that electrodes 11a, 12a situated on substrate 10 are rotated and/or deflected jointly with substrate 10. There may be relative movements of electrodes 11a, 12a relative to one another so that an acceleration error signal is generated.

One main disadvantage of the conventional structure of FIG. 1 is that electrodes 11a, 12a are placed on both sides around perforated web element 22 and therefore have an increased sensitivity to deflections of substrate 10, in particular in the z direction so that the sensitivity increases with an increase in the distance from the sensing axis which extends through the two stop elements 14 and the two connecting elements 13.

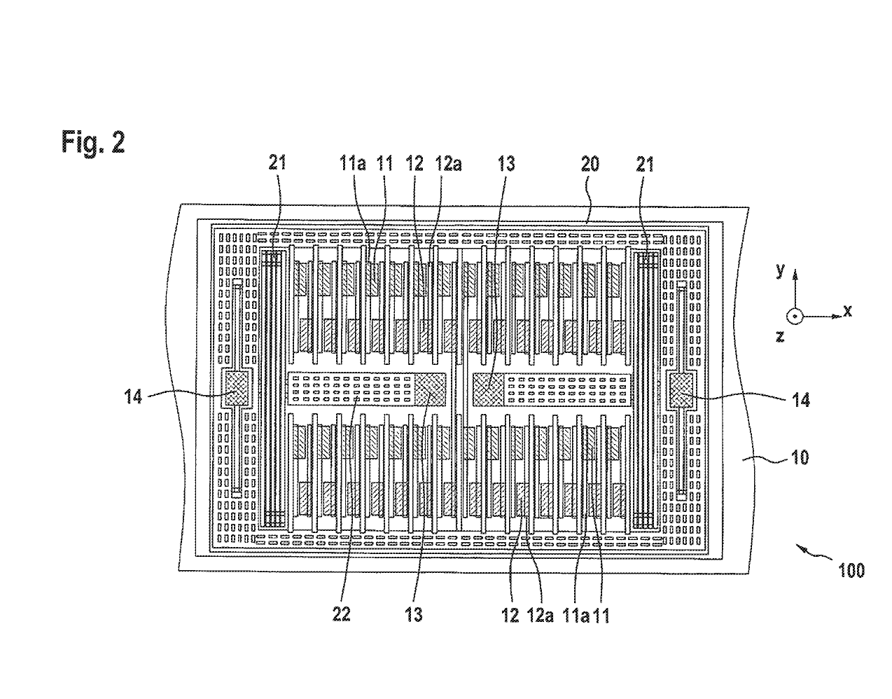

FIG. 2 shows structure 100 from FIG. 1 with an indication of the electric potentials of electrodes 11a, 12a and of connecting element 13. All first electrodes 11a and all second electrodes 12a are functionally electrically wired to one another and in this way have the same electric potential P1 and P2, respectively. Connecting element 13 is applied to ground potential PM. It is apparent that a relatively great deal of space is required for the connection of electrodes 11a and 12a and their connection to substrate 10. This is due in particular to the presence of perforated web elements 22. It is also apparent that electrodes 11a, 12a are situated a relatively great distance away from the center with connecting elements 13 in relation to the total dimension of structure 100 and are therefore sensitive to mechanical deflections or warping of substrate 10 because warping of substrate 10 has greater effects the greater the distance of electrodes 11a, 12a from the sensing axis.

A specific design or arrangement of the two spring elements 21 is proposed so that a “central suspension” for seismic mass 20 is implemented in this way.

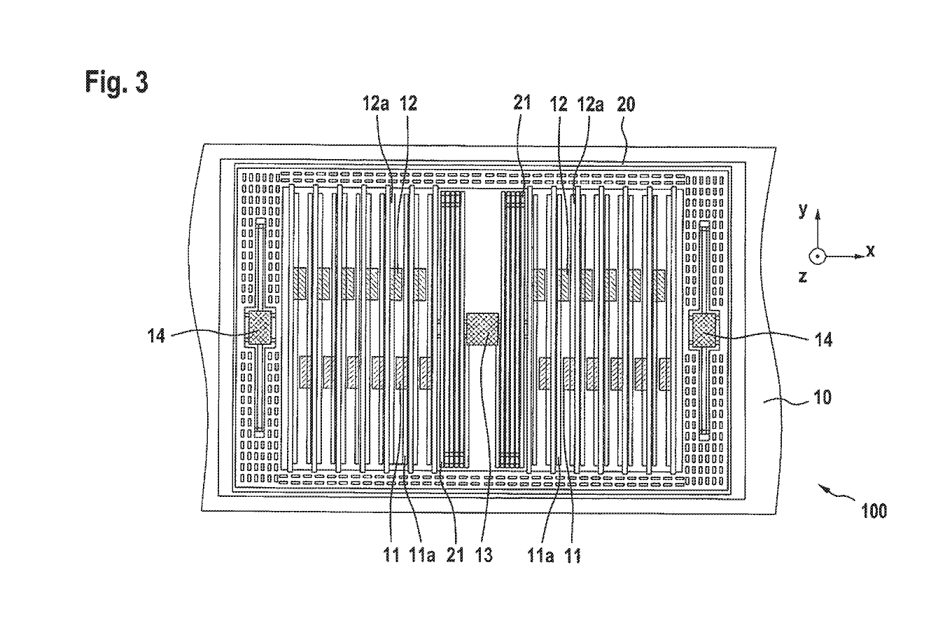

FIG. 3 shows a top view of one specific embodiment of a micromechanical structure 100 according to the present invention for a micromechanical acceleration sensor. It is apparent that, in relation to the sensing axis of seismic mass 20, a spring element 21 is situated on both sides on connecting element 13. In this way, the conventional perforated web elements 22 are unnecessary, so that additional space is available for structure 100. Electrodes 11a, 12a are connected to substrate 10 relatively centrally, so that less dependence on substrate deflections or warping for structure 100, in particular in the z direction, is to be expected. Multiple connecting webs are formed over a transverse area of seismic mass 20, so that a mechanical robustness of seismic mass 20 may be increased.

In the space thereby made free between the two spring elements 21, at least one additional electrode pair 11a, 12a may be provided (not shown). Additional structures may optionally also be provided for an optimized mechanical damping of structure 100 (not shown).

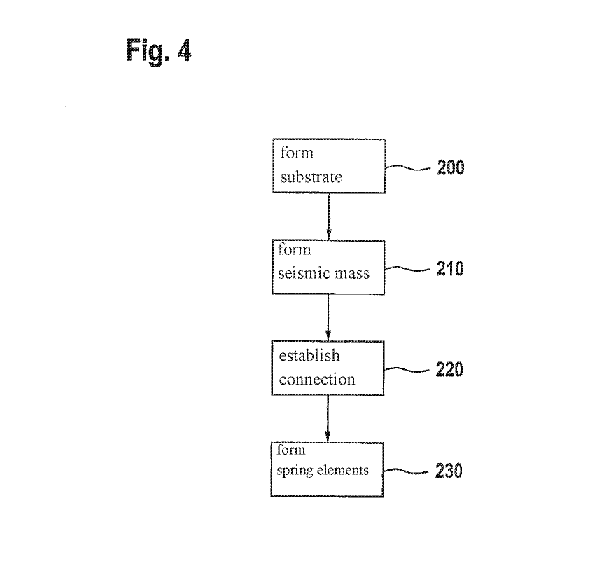

FIG. 4 shows a basic flow chart of one specific embodiment of the method for manufacturing a micromechanical structure 100 for an acceleration sensor.

In a step 200, a substrate 10 is formed including electrodes 11a, 12a provided thereon.

In a step 210, a seismic mass 20 is formed.

In a step 220, a connection of seismic mass 20 to substrate 10 is established with the aid of a central connecting element 13.

Finally, in a step 230, two spring elements 21 are formed on both sides of connecting element 13 in relation to a sensing axis of seismic mass 20.

In summary, a micromechanical structure for an acceleration sensor is provided with the present invention, which advantageously provides a reduced sensitivity to mechanical warping of the substrate (for example, due to an integration process of the structure into a sensor). This effect is easily achieved due to the arrangement of the two springs directly on the connecting element of the seismic mass on the substrate. As a result, an improved sensing characteristic for a micromechanical acceleration sensor may be achieved thereby.

It is advantageously possible to use the principle described here for other sensor technologies, for example, for piezoresistive micromechanical acceleration sensors.

Although the present invention has been described on the basis of concrete specific embodiments, it is by no means limited thereto. Those skilled in the art will thus recognize that manifold modifications are possible which in the present case have been described only in part or not at all without departing from the core of the present invention.

What is claimed is:

1. A micromechanical structure for an acceleration sensor, comprising:
a seismic mass connected to a substrate with the aid of a central connecting element;
a defined number of electrodes situated on the substrate; and
one spring element situated on each side of the connecting element in relation to a sensing axis.

2. The micromechanical structure as recited in claim 1, wherein at least one damping element is situated on the seismic mass between the two spring elements.

3. The micromechanical structure as recited in claim 1, wherein at least one additional electrode pair is situated on the substrate between the two spring elements.

4. The micromechanical structure as recited in claim 1, wherein a first electric potential is applicable to a first one of the electrodes, a second electric potential is applicable to a second one of the electrodes and a third electric potential is applicable to the connecting element.

5. An acceleration sensor including a micromechanical structure, the micromechanical structure comprising:
a seismic mass connected to a substrate with the aid of a central connecting element;
a defined number of electrodes situated on the substrate; and
one spring element situated on each side of the connecting element in relation to a sensing axis.

6. A method for manufacturing a micromechanical structure for an acceleration sensor, comprising:
forming a substrate including electrodes, provided thereon;
forming a seismic mass;
connecting the seismic mass to the substrate with the aid of a central connecting element; and
forming two spring elements on each side of the connecting element in relation to a sensing axis of the seismic mass.

7. The method as recited in claim 6, wherein first ones of the electrodes are applied to a first electric potential, second ones of the electrodes being applicable to a second electric potential and the connecting element being applicable to a third electric potential.

8. The method as recited in claim 6, wherein at least one additional damping element is situated on the seismic mass between the two spring elements.

9. The method as recited in claim 6, wherein at least two additional electrodes are situated on the substrate between the two spring elements.

10. A micromechanical structure, comprising:
providing a micromechanical structure including a seismic mass connected to a substrate with the aid of a central connecting element, a defined number of electrodes situated on the substrate, and one spring element situated on each side of the connecting element in relation to a sensing axis; and
using the micromechanical structure for a micromechanical acceleration sensor.
